(19) United States
(12) Patent Application Publication
(10) Pub. No.: US 2010/0009794 A1
(43) Pub. Date: Jan. 14, 2010

(54) SPROCKET ASSEMBLY

(76) Inventor: Douglas Chiang, Taichung Hsien (TW)

Correspondence Address: Chien-Hui Su, P. O. Box 70-121 Taichung, Taichung City, 40899, TW

(21) Appl. No.: 12/171,268

(22) Filed: Jul. 10, 2008

(51) Int. Cl. B62M 9/10; F16H 55/30

(52) U.S. Cl. 474/160

(57) ABSTRACT

A sprocket assembly includes a first sprocket set having multiple first bores defined therein. A second sprocket has multiple second bores defined therein. A supporter has multiple first fastening bores defined therein and multiple second fastening bores defined therein. The first sprocket and the second sprocket are respectively fixed on two opposite sides of the supporter. Each of the first protrusions is fixed on a corresponding one of the first fastening bores. Each of the second protrusions is fixed on a corresponding one of the second fastening bores.

### BACKGROUND OF THE INVENTION

1. Field of the Invention

The present invention relates to a sprocket assembly, and more particularly to a sprocket assembly for a bicycle.

2. Description of Related Art

A conventional bicycle sprocket assembly has at least one subassembly including a sprocket support member and two sprockets. The support member has at least one engagement portion for coupling it to a bicycle freewheel and at least one fastening portion arranged in a radially external position with respect to the engagement portion. Both sprockets are fixed on the sprocket support member on two opposite sides of the fastening portion.

The two sprockets of the conventional bicycle sprocket assembly are fastened on the sprocket support member and connected to the bicycle freewheel. The two sprockets of the conventional bicycle sprocket assembly are respectively fixed on a corresponding one of two sides of the sprocket member and at least one fastener co-axially fixes the two sprockets on the fastening portion. However, it burdens with the fastening portion a lot that the two sprockets respectively and co-axially fixed on the two opposite sides of the fastening portion. The fastening portion supports a great sudden power of the alternate movements of the two sprockets when the bicycle sprockets are shifted. Therefore, a structure fatigue will be easily happened when the single fastening portion is alternately driven by two sprockets.

The present invention has arisen to mitigate and/or obviate the disadvantages of the conventional bicycle sprocket assembly.

### SUMMARY OF THE INVENTION

The main objective of the present invention is to provide an improved sprocket assembly, which has a supporter having multiple first fastening bores to support a corresponding first bore of a first sprocket and multiple second fastening bores to support a corresponding second bore of a second sprocket.

To achieve the objective, the sprocket assembly in accordance with the present invention comprises a first sprocket set including a first sprocket, a second sprocket and a supporter for co-axially combining the first sprocket and the second sprocket. The first sprocket has multiple first bores defined therein. The second sprocket has multiple second bores defined therein. The supporter has multiple first fastening bores defined therein and multiple second fastening bores defined therein. The first sprocket and the second sprocket are respectively fixed on two opposite sides of the supporter. Each of the multiple first bores has a corresponding first fastening bore aligning with the first bore and simultaneously engaged by a fastener. Each of the multiple second bores has a corresponding second fastening bore aligning with the second bore and simultaneously engaged by a fastener.

Each of the first fastening bores has a corresponding first bore aligning therewith and the first sprocket is fixed on a first surface of the supporter. Each of the second fastening bores has a corresponding second bore aligning therewith and the second sprocket is fixed on a second surface of the supporter. Therefore, the first fastening bores separately support the power from the first sprocket and the second fastening bores separately support the power from the second sprocket. From the point of view of the connecting rigidity, the present invention provides a better structure strength than those of the prior art in which the sprockets are fixed in the different fastening bores of the supporter for preventing the structure fatigue from arising.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a sprocket assembly in accordance with the present invention;

FIG. 2 is a side cross-sectional view of the sprocket assembly in FIG. 1;

FIG. 3 is an exploded perspective view of the sprocket assembly in FIG. 1;

FIG. 4 is a cross-sectional view of a second embodiment of the sprocket assembly of the present invention, wherein a second sprocket set and a third sprocket set are sequentially mounted to the sprocket assembly in FIG. 1; and

FIG. 5 is an exploded perspective view of the sprocket assembly in FIG. 4.

### DETAILED DESCRIPTION OF THE INVENTION

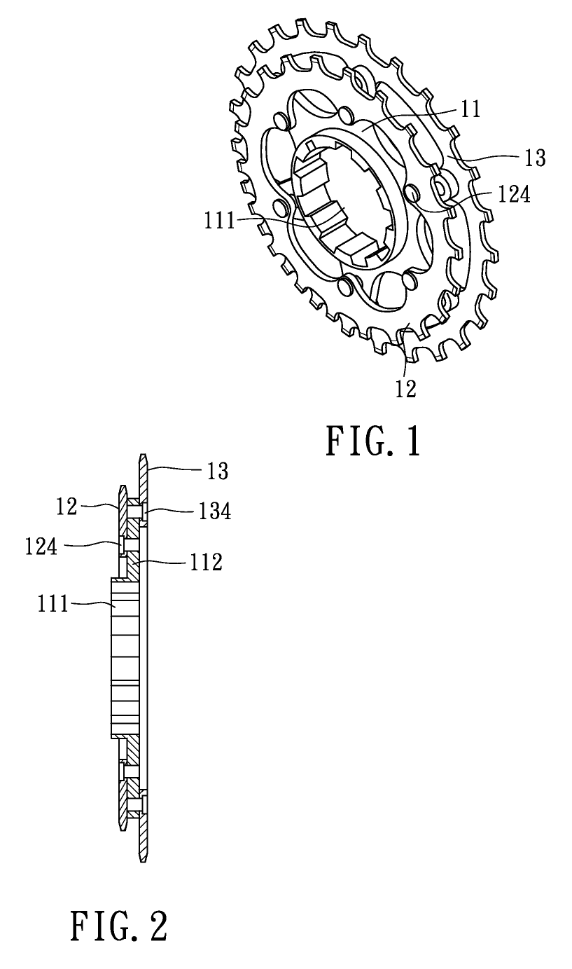

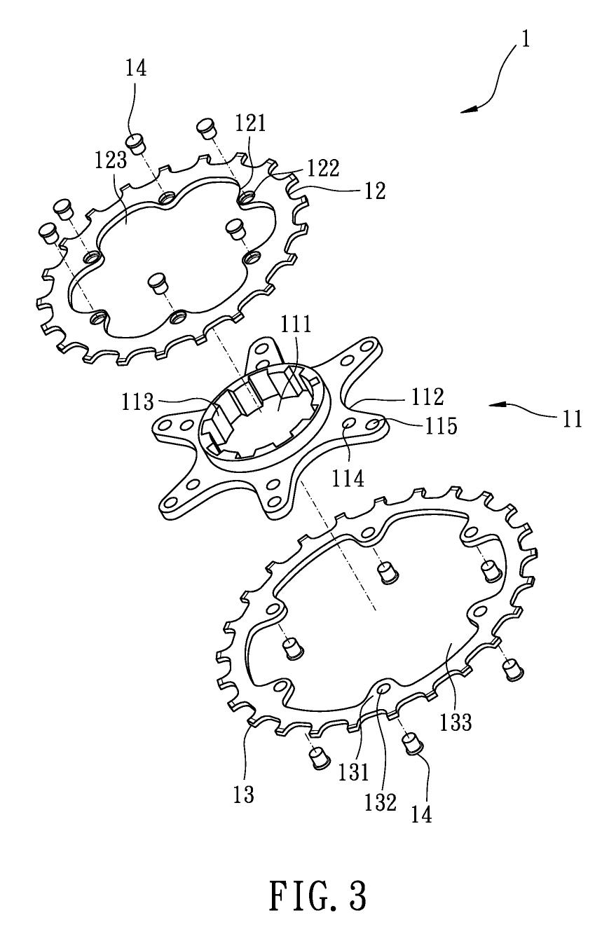

Referring to the drawings and initially to FIGS. 1-3, a sprocket assembly in accordance with the present invention comprises a first sprocket set (1) including a first sprocket (12), a second sprocket (13) and a supporter (11) for co-axially combining the first sprocket (12) and the second sprocket (13).

The first sprocket (12) has a first series of teeth radially and outwardly extending therefrom, and selectively meshed by a chain of a bicycle. The first sprocket (12) has a hole (123) centrally defined therein and extending therethrough, and multiple first protrusions (121) radially inwardly extending from an inner periphery of the hole (123) in the first sprocket (12). Each of the multiple first protrusions (121) has a first bore (122) defined therein and each of the first bores (122) is adjacent to the hole (123) of the first sprocket (12).

The second sprocket (13) has a structure similar to the first sprocket (12). The second sprocket (13) has a second series of teeth outwardly radially extending therefrom and selectively meshed by the chain of the bicycle. The second sprocket (13) has an outer diameter greater than that of the first sprocket (12). The second sprocket (13) has a hole (133) centrally defined therein and extending therethrough, and an inner diameter of the hole (133) in the second sprocket (13) is greater than that of hole (123) in the first sprocket (12). Multiple second protrusions (131) radially inwardly extend from an inner periphery of the hole (133) in the second sprocket (13). Each of the multiple second protrusions (131) has a second bore (132) defined therein and the second bores (132) are adjacent to the hole (133) in the second sprocket (13).

The supporter (11) has multiple fastening portions (112) radially extending therefrom, and the first sprocket (12) and the second sprocket (13) are respectively fixed on two opposite sides of the supporter (11). Each of the first protrusions (121) is fixed on a corresponding one of the fastening portions (112). The corresponding fastening portion (112) relative to the first protrusion (121) has a first fastening bore (114) defined therein and aligning with the first bore (122) in the corresponding first protrusion (121). Each of the second protrusions (131) is fixed on a corresponding one of the fastening portions (112). The corresponding fastening portion (112) relative to the second protrusion (131) has a second fastening bore (115) defined therein and aligning with the second bore (132) in the corresponding second protrusion (131). In the preferred embodiment of the present invention, the supporter (11) has an engaging hole (111) centrally defined therein and a series of inner teeth inwardly radially extending from an inner periphery of the engaging hole (111). The supporter (11) has multiple fastening portions (112) equidistantly and radially extending therefrom. Each of fastening portions (112) has a first fastening bore (114) and a second fastening bore (115) defined therein. The second fastening bore (115) is positioned outer than the first fastening bore (114) in each of the fastening portions (112). Each of the first fastening bore (114) aligns with a corresponding one of the first bores (122) in the first sprocket (12) when the first sprocket (12) is co-axially attached to the supporter (11) and each of the second fastening bore (115) aligns with a corresponding one of the second bores (132) of the second sprocket (13) when the second sprocket (13) is co-axially attached to the supporter (11).

The supporter (11) has a first surface and a second surface opposite to the first surface. The first sprocket (12) is fixed on the first surface of the supporter (11) and the second sprocket (13) is fixed on the second surface of the supporter (11). Multiple fasteners (14) are respectively engaged to a corresponding one of the first fastening bores (114) via a corresponding first bore (122) for holding the first sprocket (12) in place on the supporter (11) when the corresponding first fastening bore (114) relative to the first protrusion (121) aligns with the first bore (122) in the corresponding first protrusion (121). Multiple fasteners (14) are respectively engaged to a corresponding one of the second fastening bores (115) via a corresponding second bores (132) for holding the second sprocket (13) in place on the supporter (11) when the corresponding second fastening bore (115) relative to the second protrusion (13 1) aligns with the second bore (132) in the corresponding second protrusion (13). In the preferred embodiment of the present invention, each of the first protrusions (131) is fixed on the first surface of a corresponding one of the fastening portions (112) and each of the first bore (122) aligns with a corresponding first fastening bore (114) and is engaged by a corresponding fastener (14) for supporting a power transmitted from the first sprocket (12) when the sprockets are shifted. Each of the second protrusions (131) is fixed on the second surface of a corresponding one of the fastening portions (112) and each of the second bore (132) aligns with a corresponding second fastening bore (115) and is engaged by a corresponding fastener (14) for supporting a power transmitted from the second sprocket (13) when the sprockets are shifted. Therefore, the first fastening bores (114) separately support the power from the first sprocket (12) and the second fastening bores (115) separately support the power from the second sprocket (13) for preventing a structure fatigue from arising.

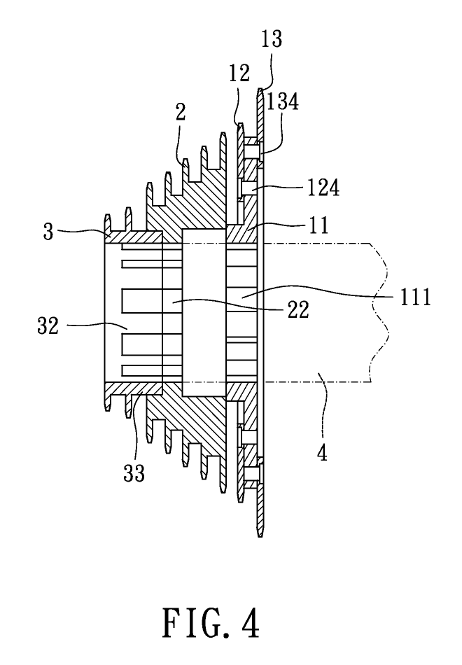

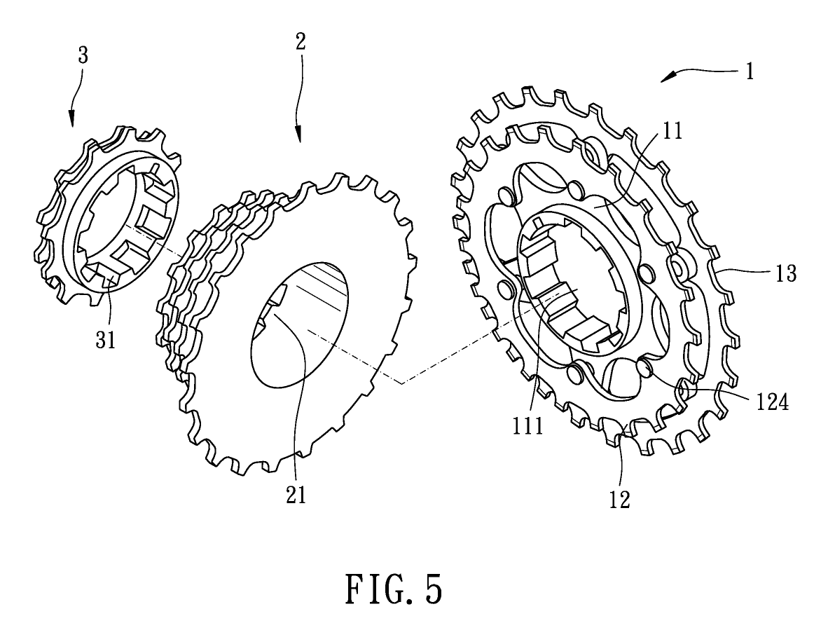

With reference to FIG. 4 and FIG. 5 that show a second embodiment of the sprocket assembly in accordance with the present invention, in this embodiment, the first sprocket set (1) is co-axially attached to a second sprocket set (2) from one end of the second sprocket set (2). The second sprocket set (2) is co-axially formed with multiple sprockets. The second sprocket set (2) has an engaging hole (21) centrally formed therein and a series of inner teeth inwardly radially formed on the engaging hole (21). A third sprocket set (3) is co-axially attached to the second sprocket set (2) from another end of the second sprocket set (2) and the third sprocket set (3) is co-axially formed with multiple sprockets. The third sprocket set (3) has an engaging hole (31) centrally formed therein and a series of inner teeth inwardly radially formed on the engaging hole (31). The freewheel (4) of the bicycle is sequentially inserted into the engaging hole (111) of the first sprocket set (1), the engaging hole (21) of the second sprocket set (2), and the engaging hole (31) of the third sprocket set (3) for simultaneously engaging the first sprocket set (1), the second sprocket set (2), and the third sprocket set (3). From the point of view of the connecting rigidity, the present invention provides a better structure strength than those of the prior art in which the sprockets are fixed in the different fastening bores of the supporter (11) for preventing the structure fatigue from arising.

Although the invention has been explained in relation to its preferred embodiment, it is to be understood that many other possible modifications and variations can be made without departing from the spirit and scope of the invention as hereinafter claimed.

What is claimed is:

1. A sprocket assembly comprising:
a first sprocket set including:
a first sprocket having a hole centrally defined therein and extending therethrough, multiple first protrusions radially and inwardly extending from an inner periphery of the hole in the first sprocket, each of the multiple first protrusions having a first bore defined therein;
a second sprocket having a hole centrally defined therein and extending therethrough, multiple second protrusions radially and inwardly extending from an inner periphery of the hole in the second sprocket, each of the multiple second protrusions having a second bore defined therein;
a supporter having multiple fastening portions radially extending therefrom, the first sprocket and the second sprocket respectively fixed on two opposite sides of the supporter, each of the first protrusions fixed on a corresponding one of the fastening portions, the corresponding fastening portion relative to the first protrusion having a first fastening bore defined therein and aligning with the first bore in the corresponding first protrusion, each of the second protrusions fixed on a corresponding one of the fastening portions, the corresponding fastening portion relative to the second protrusion having a second fastening bore defined therein and aligning with the second bore in the corresponding second protrusion.

2. The sprocket assembly as claimed in claim 1 further comprising multiple fasteners respectively engaged to a corresponding one of the first fastening bores via a corresponding first bore for holding the first sprocket in place on the supporter when the corresponding first fastening bore relative to the first protrusion aligning with the first bore in the corresponding first protrusion and multiple fasteners respectively engaged to a corresponding one of the second fastening bores via a corresponding second bores for holding the second sprocket in place on the supporter when the corresponding second fastening bore relative to the second protrusion aligning with the second bore in the corresponding second protrusion.

3. The sprocket assembly as claimed in claim 2, wherein the supporter has an engaging hole centrally defined therein and a series of inner teeth inwardly radially extending from an inner periphery of the engaging hole for adapting to engage a freewheel of a bicycle.

4. The sprocket assembly as claimed in claim 1 further comprising a second sprocket set co-axially attached to the first sprocket set and a third sprocket set co-axially attached to the second sprocket set, the second sprocket set having an engaging hole centrally formed therein and the third sprocket set having a engaging hole centrally formed therein;
whereby the first sprocket set, the second sprocket set and the third sprocket set are co-axially assembled for adapting to simultaneously and co-axially engage the freewheel of the bicycle when assembling.
